(19) United States
(12) Patent Application Publication
(10) Pub. No.: US 2013/0100693 A1
(43) Pub. Date: Apr. 25, 2013

(54) LED TAIL LIGHT WITH SIDE MARKERS

(71) Applicant: Kathleen Anne Johnson, Richfield, WI (US)

(72) Inventor: Thomas Rogers, Marshall, MI (US)

(21) Appl. No.: 13/343,320

(22) Filed: Jan. 4, 2012

Related U.S. Application Data
(60) Provisional application No. 61/429,716, filed on Jan. 4, 2011.

(51) Int. Cl. B60Q 1/26

(52) U.S. Cl. CPC B60Q 1/26
USPC 362/545; 362/544

(57) ABSTRACT

A tail light assembly includes a housing, one or more lights arranged to emit light in a first direction, and a side marker connected to the housing and arranged to emit light in a second direction, approximately perpendicular to the first direction. The lights may include one or more light emitting diodes (“LEDs”) to reduce power consumption of the tail light assembly.

### CROSS-REFERENCE TO RELATED APPLICATION

This application claims benefit from U.S. Provisional Patent Application No. 61/429,716 entitled “LED Tail Light with Side Markers,” filed on Jan. 4, 2011 which is hereby incorporated in its entirety by reference.

### BACKGROUND

The present invention relates to a tail light for use on a vehicle such as an agricultural vehicle.

Agricultural field equipment, such as wagons, plows, tractors and the like, is commonly towed along public roads and highways. During transit, the equipment moves and stops at the direction of the towing vehicle. The towed equipment, however, often lacks lights such as tail lights that are integrated with the towing vehicle to provide warning signals to traffic and other surrounding vehicles. Tail light assemblies have therefore been developed to provide warning lights for towed vehicles and equipment.

In years past, very few federal regulations were in place to govern the use of lights on vehicles towed on public roads or highways, such as towed agricultural field equipment. Recently, however, there has been increased regulation of the use of lights for such towed equipment. Regulations such as SAE 585/J974, ANSI/ASAE 5279.15 and SAE J/845 govern the type of lighting, number of lights and lighting configuration for such tail lights. There is therefore a need for tail lights that comply with these regulations.

Traditionally, remote tail lights used incandescent bulbs to light the tail light lamps. Remote tail lights, however, commonly draw power from the towing vehicle. High power draw by the remote tail lights can lead to battery wear and cause other undesirable effects. Therefore, a new tail light design is needed to decrease the overall power consumption and power drain on the towing vehicle while still complying with government regulations.

### SUMMARY

A tail light assembly is generally presented. The tail light assembly includes a housing, a tail light arranged to emit light in a first direction, and a side marker connected to the housing and arranged to emit light in a second direction approximately perpendicular to the first direction. The tail light may include one or more light emitting diodes (“LEDs”).

In some embodiments, the tail light assembly includes two tail lights connected to the housing and arranged to emit light in a first direction. The tail lights may each include one or more LEDs. The light assembly may include a second side marker connected to the housing. The second side marker may be arranged to emit light in a direction approximately opposite the direction of the first side marker.

### BRIEF DESCRIPTION OF THE DRAWINGS

The invention may be better understood by reference to the following detailed description taken in connection with the following illustrations, wherein:

FIG. 1 illustrates a perspective view of a dual tail light assembly.

FIG. 2 illustrates a front view of a dual tail light assembly.

FIG. 3 illustrates a side view of a dual tail light assembly.

FIG. 4 illustrates a top view of a dual tail light assembly.

FIG. 5 illustrates a perspective view of a single tail light assembly.

FIG. 6 illustrates a front view of a single tail light assembly.

FIG. 7 illustrates a side view of a single tail light assembly.

FIG. 8 illustrates a top view of a single tail light assembly.

FIG. 9 illustrates a front view of a dual tail light assembly having two side markers.

FIG. 10 illustrates a front view of a single tail light assembly having two side markers.

### DETAILED DESCRIPTION OF THE INVENTION

Reference will now be made in detail to embodiments of the invention, examples of which are illustrated in the accompanying drawings. It is to be understood that other embodiments may be utilized and structural and functional changes may be made without departing from the respective scope of the invention.

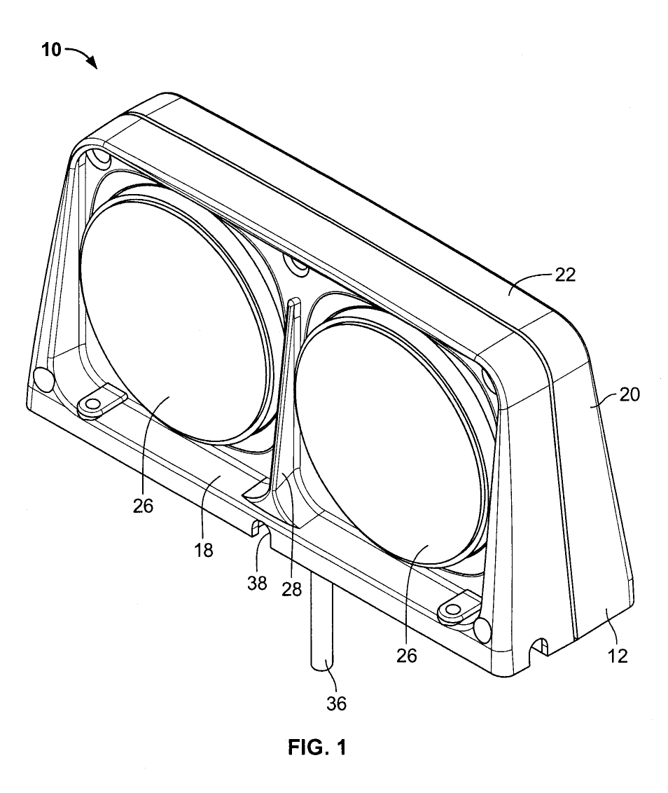

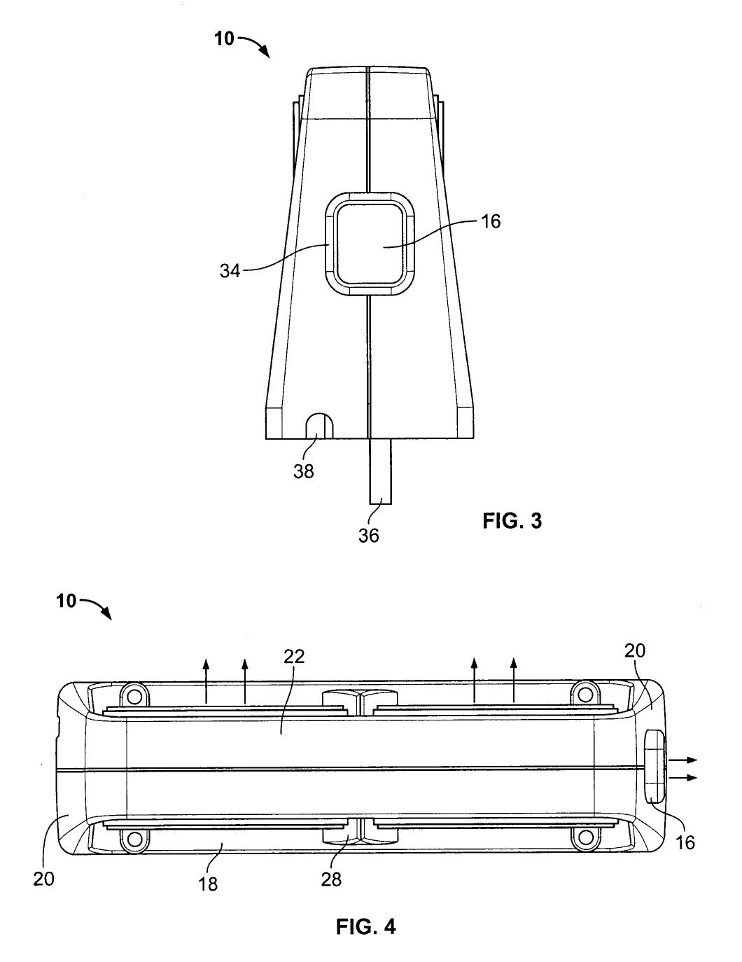

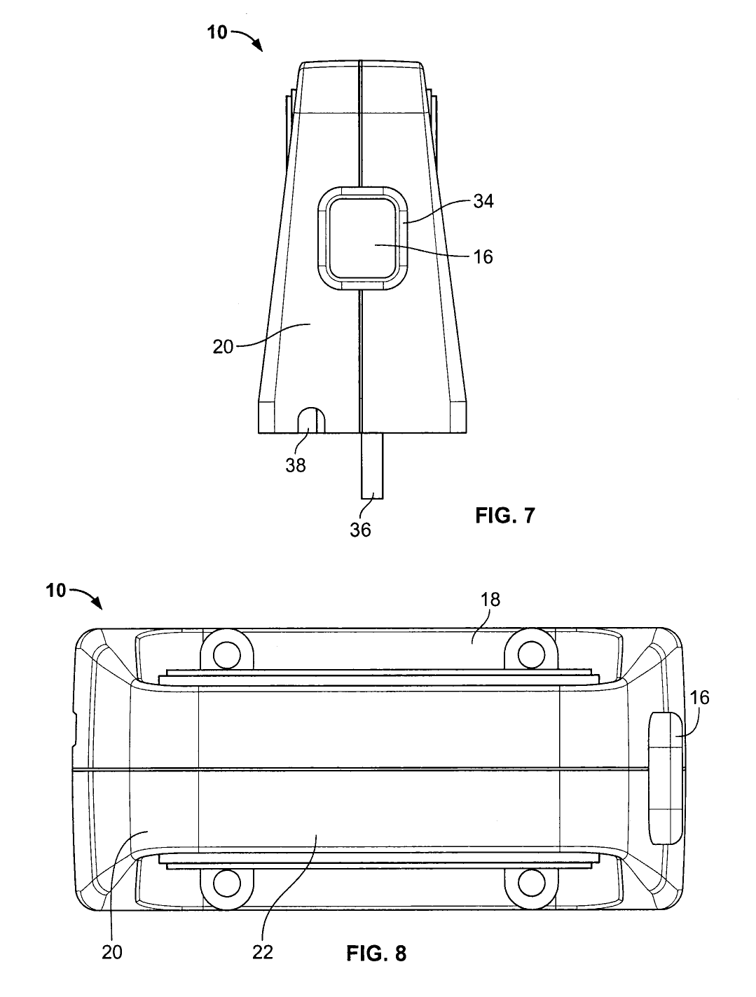

A tail light assembly 10 is presented, as illustrated in FIGS. 1-10. The tail light assembly 10 may comprise a housing 12, one or more tail lights 14, and one or more side markers 16. The tail light assembly 10 may connect to a towing vehicle to power and control the tail lights 14 and side markers 16.

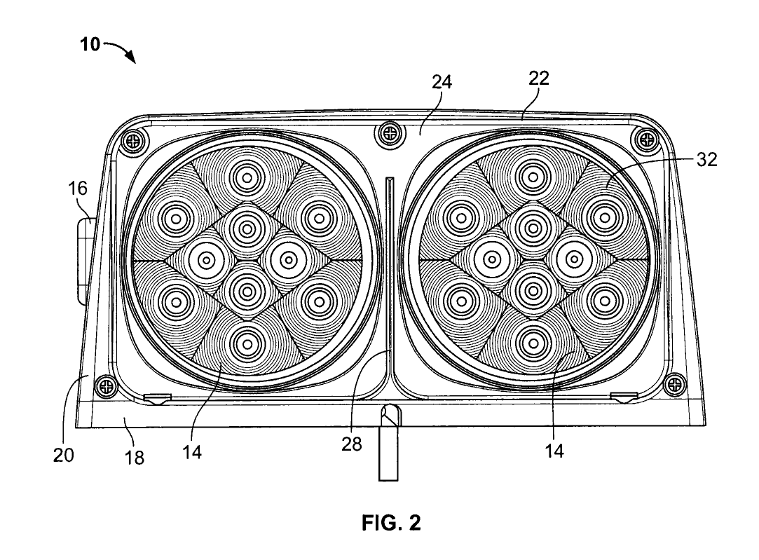

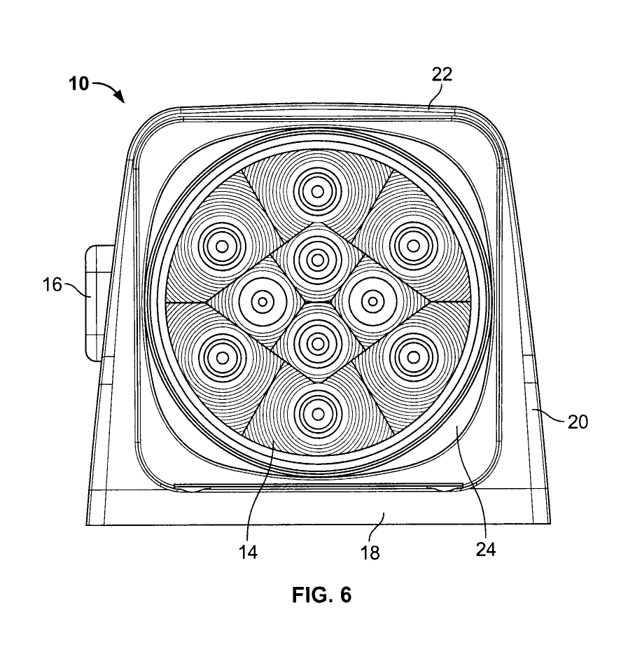

The housing 12 may be of any appropriate size and shape and may be composed of any appropriate material, such as plastic, metal or the like. The housing 12 may include a generally flat base 18 and a pair of sloped end surfaces 20. The end surfaces 20 may be joined together by a top surface 22. The end surfaces 20 may be sloped in one or more directions. For example, the end surfaces 20 may be wider near the base 18 and narrower near the top surface 22. The end surfaces 20 may further be angled towards one another, as best shown in FIGS. 2 and 6.

The housing may include a back surface 24. The back surface 24 may be any appropriate size and shape and may be arranged approximately perpendicular to the base 18. The back surface 24 may include one or more openings 26 to house the tail lights 14.

In an embodiment illustrated in FIGS. 1-4 and 9, the tail light assembly 10 may be a dual light assembly. For example, the tail light assembly 10 may include two openings 26 to receive two tail lights 14. The tail lights 14 may be positioned adjacent to one another and may face the same direction. The housing may include a central rib 28 positioned between the two tail lights 14. The central rib 28 may project outward from the back surface 24 and may extend up from the base 18, terminating at or near the top surface 22.

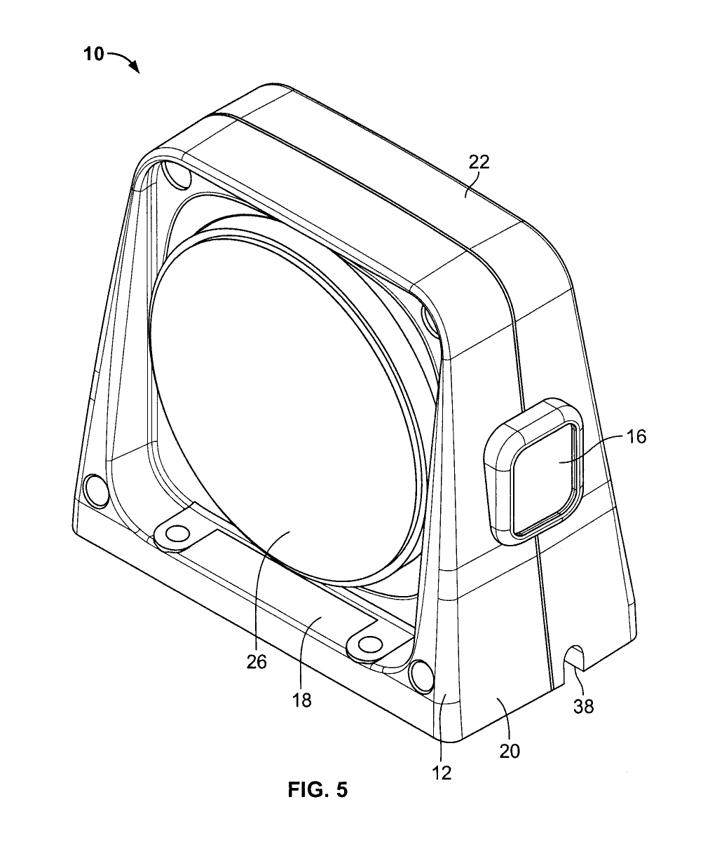

In some embodiments, such as illustrated in FIGS. 5-8 and 10, the tail light assembly 10 may be a single light assembly. For example, the tail light assembly may include a single opening to receive one tail light 14. The tail light 14 may be generally centered on the back surface 24.

The tail light assembly 10 may utilize one or more Light Emitting Diodes (“LEDs”) to illuminate the tail lights 14. Traditionally, tail light assemblies included incandescent light bulbs to light the rear light lamps. Incandescent light bulbs, however, commonly draw more power than LEDs. By way of a non-limiting example, a tail light assembly 10 having two incandescent bulb-powered tail lights 14 may draw up to 3 amps while a tail light assembly 10 having two LED-powered tail lights 14 may draw as little as 0.25 amps. Therefore, by utilizing LED-powered rear lights, the tail light assembly 10 may reduce its overall power draw.

The tail lights 14 may include any number of LEDs, such as 16 LEDs per tail light 14. The LEDs may be spaced and oriented to direct the light in a desired direction, such as generally perpendicular to and away from the back surface 24. The LEDs may be any color, such as amber, orange or yellow, to provide the desired light color. Further, the tail lights 14 may include a lens cap 32. The lens cap 32 may be composed of a transparent or translucent material to allow light therethrough. The lens cap 32 may be colored, such as amber, orange or yellow, to further provide the desired color of the tail light 14. Alternatively, the lens cap 32 may be clear.

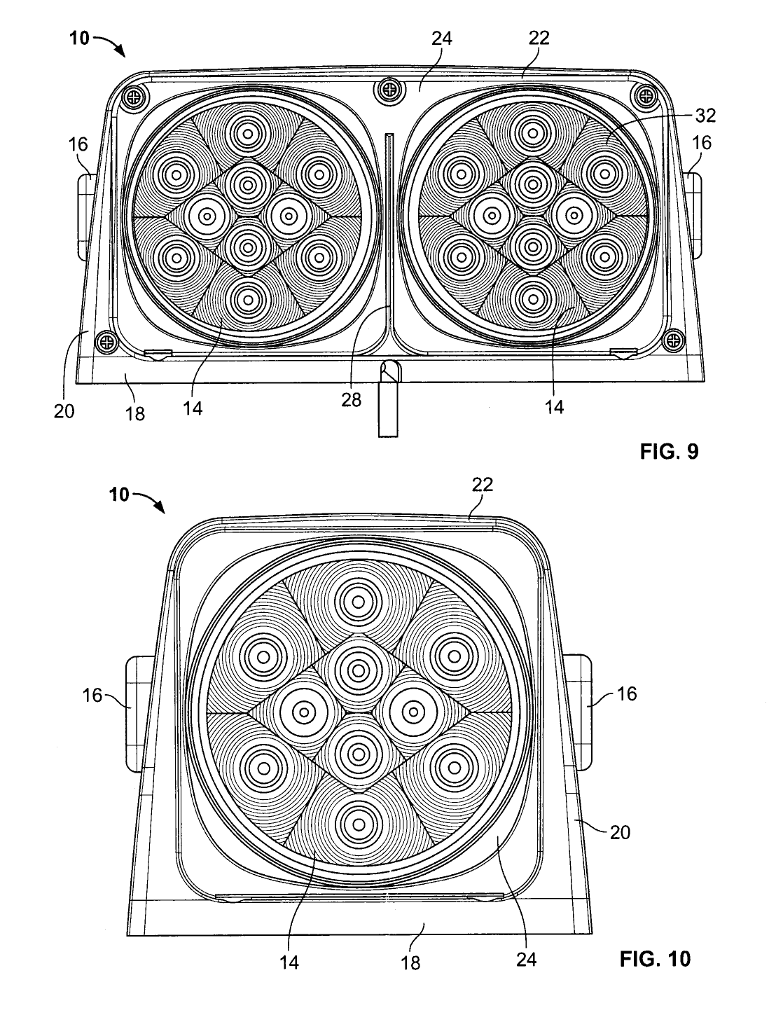

The tail light assembly 10 may include one or more side markers 16 to provide side lighting. The side markers 16 may comprise a light positioned at any appropriate position on the housing 12, such as at the end surfaces 20. The side markers 32 may be any appropriate size and shape, such as rectangular (as shown in the Figures) circular, ovular, square, or any other shape. The light assembly may include a single side marker 16 on one end surface 20 or a side marker 16 on each end surface 20, as shown in FIGS. 9 and 10.

The side markers 16 may provide side lighting that is focused approximately perpendicular to the direction of the tail lights 14. Traditionally, incandescent rear lights included a ridged or ring portion on the lens cap to diffuse the incandescent light toward the sides of the tail light assembly 10. The light emitting properties of LEDs, however, are not the same as the light emitting properties of incandescent lights. Therefore, the side markers 16 provide side illumination not otherwise possible with LED-powered tail lights 14 and traditional lens caps.

The side markers 16 may be powered by incandescent bulbs or by LEDs. In some embodiments, the side markers 16 may be powered by LEDs that are focused away from the direction of the tail light 14 LEDs. For example, the side marker 16 LEDs may be focused in a direction approximately perpendicular to the tail light 14 LEDs, as shown by the arrows representing light direction in FIG. 4.

The side markers 16 may include a shroud 34. The shroud 34 may be any appropriate size and shape, such as rectangular, circular or square. The shroud 34 may extend from the end surface 20 and surround a portion of the perimeter of the side marker 16, such as the entire perimeter. In some embodiments, the side marker 16 is powered by an incandescent light bulb. The shroud 34 may focus the incandescent light away from the light emitted by the tail lights 14.

The tail light assembly 10 may include a cord 36. The cord 36 may be any appropriate size and length and may include any appropriate number of wires. For example, the cord 36 may include power wires, such as a first and second wire to provide DC power to the tail light assembly 10. The cord 36 may further include one or more control wires. The control wires may provide a signal to the tail lights 14 and a signal to the side markers 16 to turn the lights on and off. The housing may include a cord opening 38. The cord opening 38 may be any appropriate size and shape, such as semi-circular. The cord opening 38 may allow the cord 36 to pass therethrough and extend to connect with a towing vehicle.

In operation the tail light assembly 10 is placed on a towed vehicle and connected to a towing vehicle by way of the cord 36. The towing vehicle provides power and control signals to the tail light assembly 10 to actuate the LED lights of the tail lights 14 and to actuate the side markers 16. In some embodiments, the lights may be attached to the towed vehicle with magnets.

The invention has been described above and, obviously, modifications and alternations will occur to others upon a reading and understanding of this specification. Additionally, the various features of the embodiments shown herein are not limited to the embodiments shown and, rather, may be mixed and matched to obtain a desired tail light assembly. The claims as follows are intended to include all modifications and alterations insofar as they come within the scope of the claims or the equivalent thereof.

Having thus described the invention, we claim:

1. A tail light assembly comprising:
a housing;
a light connected to said housing and positioned to emit light in a first direction;
a first side marker connected to said housing and positioned to emit light in a second direction approximately perpendicular to said first direction.

2. The tail light assembly of claim 1, wherein said light includes at least one light emitting diode (“LED”).

3. The tail light assembly of claim 1, wherein said side marker is an incandescent light.

4. The tail light assembly of claim 1 further comprising a shroud positioned about said side marker.

5. The tail light assembly of claim 1 further comprising a second side marker positioned on a side of said housing opposite said first side marker.

6. The tail light assembly of claim 1, wherein said housing comprises a first sidewall and a second sidewall.

7. The tail light assembly of claim 6, wherein said side marker is connected to said first sidewall of said housing.

8. A tail light assembly comprising:
a housing;
a first light connected to said housing and positioned to emit light in a first direction;
a second light connected to said housing and positioned to emit light in said first direction;
a first side marker connected to said housing and positioned to emit light in a second direction approximately perpendicular to said first direction.

9. The tail light assembly of claim 8 further comprising a rib positioned between said first light and said second light.

10. The tail light assembly of claim 8, wherein said first light includes at least one LED.

11. The tail light assembly of claim 8, wherein said side marker is an incandescent light.

12. The tail light assembly of claim 8 further comprising a shroud positioned about said side marker.

13. The tail light assembly of claim 8 further comprising a second side marker positioned on a side of said housing opposite said first side marker.

14. A tail light assembly comprising:
a housing connected to a surface of a towed vehicle;
a first light connected to said housing and positioned to emit light in a first direction;
a first side marker connected to said housing and positioned to emit light in a second direction approximately perpendicular to said first direction.

15. The tail light assembly of claim 14, wherein said tail light assembly is configured to receive an input signal from a towing vehicle.

16. The tail light assembly of claim 14, wherein said first light includes at least one LED.

17. The tail light assembly of claim 14 further comprising a second light connected to said housing and positioned to emit light in said first direction.

18. The tail light assembly of claim 14 wherein said side marker is an incandescent light.

19. The tail light assembly of claim 14 further comprising a shroud positioned about said side marker.

20. The tail light assembly of claim 14 further comprising a second side marker positioned to emit light in a third direction, approximately opposite said second direction.
